(19) United States
(12) Patent Application Publication
(10) Pub. No.: US 2019/0180790 A1
(43) Pub. Date: Jun. 13, 2019

(54) SYSTEM AND METHOD FOR DISPLAYING INDEXED MOMENTS ON A VIDEO PLAYER

(71) Applicant: Rohan Rehman, Tokyo (JP)

(72) Inventor: Rohan Rehman, Tokyo (JP)

(21) Appl. No.: 16/046,854

(22) Filed: Jul. 26, 2018

Related U.S. Application Data
(60) Provisional application No. 62/596,389, filed on Dec. 8, 2017.

(51) Int. Cl. G11B 27/34; G06F 17/30; G06F 3/0484

(52) U.S. Cl. CPC G11B 27/34; G06F 3/04842; G06F 17/30849; G06F 17/30858

(57) ABSTRACT

System and method for providing enhanced navigation of stored and streamed digital video content based upon indexed moments. The system and method includes generation and storage of moments index, as well as navigation based on moments in the moment index.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57, and should be considered a part of this specification.

### BACKGROUND

### Field

The present invention is directed to a system and method for indexing moments in a video, and more particularly to a graphical user interface for displaying indexed moments on a video player.

### Description of the Related Art

Modern video codecs and increases in cellular broadband network speeds have greatly improved the video image quality. In turn the delivery of high quality video on a variety of devices (e.g., television, laptop computers, mobile devices including smartphones, such as ios player, android player). However, very little has been done on improvements to how video is viewed by consumers.

Current video player interfaces have remained unchanged since the 1990s. A single still image (“thumbnail”) is used as a placeholder for the video and displayed before the user initiates playback. The video thumbnail and the title associated with it remain the main way in which video content is communicated. Additionally, current video player interfaces for navigating actions include: play, pause, stop and a scrub bar to freely seek the video forward or backward, speed up play speed, slow down play speed, play in reverse, and jumping forward for a set amount of time or jumping backward for a set amount of time.

However, current video player interfaces are unable to communicate to the user context in relation to certain points within the video, and to meet the demands of current video ingestion usage, which is selective and occurs in short bursts, as noted above. Users often do not have time to view entire video content and need to be able to quickly access important moments in a video (e.g., while on a break from work, during their commute on a bus or subway, etc.). Further, many social media platforms (e.g., Instagram) force users to share one moment in posts on their platforms, and users must decide which is the best moment (e.g., in a video) to share. Current trimming tools slow down the sharing process on social media. In determining how to trim a video, for example to then share on a social media platform, users can feel pressure to share only one moment and cut off the rest of the recorded video. However, current internet and cellular bandwidth speeds are sufficient enough, making the trimming process unnecessary.

### SUMMARY

The present invention addresses the drawbacks of video player interfaces, including those identified above. In one aspect, the invention allows users to index moments consistent with modern behaviors (e.g., “tag styled” legend/key) in order to provide better video content insight and allow for ease in consuming specific moments in a video content. In another aspect, the invention provides a system and method for communicating to a user moments in a video, when they occur, and what they relate to (e.g., type of event or action), thereby providing the user information on the content of the video at specific points in relation to the video duration without requiring user interaction.

In accordance with one aspect, a computer implemented method for generating and displaying indexed moments on a video player is provided. The method comprises receiving a video content selection, receiving a selection of one or more moments in the video content, selecting one or more legends and one or more keys from an indexing system, linking each of the one or more moments in the video content to one of the one or more legends and to one of the one or more keys to generate one or more indexed moments for the video content, saving the one or more indexed moments, and receiving and saving identifying information associated with the indexed moment. The method further comprises generating in real time a graphical user interface (GUI) that displays a graphical indication of the one or more indexed moments as color-coded indicators, where the GUI temporarily displays the identifying information associated with the indexed moment when a cursor or pointer hovers over the indexed moment.

In accordance with another aspect, a system for generating indexed moments on a video player is provided. The system comprises one or more computing devices including one or more processors, one or more memory devices. The system also comprises an application stored in the one or more memory devices and executable by the one or more processors to receive, process, and respond to data requests. The one or more processors are operable to perform operations comprising receiving a video content selection, receiving a selection of one or more moments in the video content, selecting one or more legends and one or more keys from an indexing system, linking each of the one or more moments in the video content to one of the one or more legends and to one of the one or more keys to generate one or more indexed moments for the video content, saving the one or more indexed moments, and receiving and saving identifying information associated with the indexed moment. The one or more processors are also operable to generate in real time a graphical user interface (GUI) that displays a graphical indication of the one or more indexed moments as color-coded circular markers, where the GUI temporarily displays the identifying information associated with the indexed moment when a cursor or pointer hovers over the indexed moment.

In accordance with another aspect, a computer program product for generating indexed moments on a video player is provided. The computer program product is stored on a computer readable medium comprising instructions that when executed on a server cause the server to perform operations comprising receiving a video content selection, receiving a selection of one or more moments in the video content, selecting one or more legends and one or more keys from an indexing system, linking each of the one or more moments in the video content to one of the one or more legends and to one of the one or more keys to generate one or more indexed moments for the video content, saving the one or more indexed moments, and receiving and saving identifying information associated with the indexed moment. The operations also comprise generating in real time a graphical user interface (GUI) that displays a graphical indication of the one or more indexed moments as color-coded indicators, where the GUI temporarily displays the identifying information associated with the indexed moment when a cursor or pointer hovers over the indexed moment.

### BRIEF DESCRIPTION OF THE DRAWINGS

FIG. 1A shows a cross-functional flow chart for a process for implementing the creation of moments on touch devices via an interface.

FIG. 1B shows a cross-functional flow chart for a process for implementing the creation of moments on an offline electronic device.

FIG. 2 is a schematic representation of a timeline in video player graphical user interface.

FIGS. 3A-3F are schematic representations of the timeline in a display screen of various electronic devices.

FIGS. 4A-4C show schematic representations of a graphical user interface provided by the video player.

FIGS. 5A-5C show schematic representations of a graphical user interface provided by the video player.

FIGS. 6A-6C show schematic representations of a graphical user interface provided by the video player.

FIG. 7 shows a block diagram of a computer system with which certain systems and methods discussed herein may be implemented.

### DETAILED DESCRIPTION

### Video Player Interface

A “Video Player Interface,” as described herein, provides an intuitive user interface for interacting with video recordings via user interaction with a set of one or more moments indexed relative to the video to identify different actions or events for the user without requiring the user to first interact with the video or graphical user interface (GUI) of the Video Player Interface.

As further described below, the Video Player Interface allows the user to readily identify the type of action or event at the moment in the video via a coded identifier on the timeline that is shown on the GUI of the Video Player Interface. Optionally, the coded identifier can be one of a plurality of different colors. Alternatively, the coded identifier can optionally be one of a plurality of different shapes. The GUI can optionally provide a legend that the user can reference to identify the types of actions or events shown along the timeline by the indexed moments. For example, where the video is of a sporting event, the different indexed moments can correspond to scoring plays, fouls, missed scoring plays, etc. In another example, where the video is of a cooking show, the different coded identifiers can correspond to the presentation of the final dish, presentation of awards, failure moments, etc. In still another example, where the video is of a travel show, the different coded identifiers can correspond to locations of tourist attractions, locations of specific sceneries (e.g., beaches, mountains, wildlife, etc.). In still another embodiment, in the context of a personal home video, the different coded identifiers can correspond to different scenes or different people (e.g., kids, family, etc.).

The user can optionally obtain additional information about the action or event at the moment on the timeline by, for example, hovering over the moment with a pointer (e.g., for a set period of time), tapping (e.g., selecting) the moment with a pointer, or other suitable ways of selecting the moment. When the GUI is implemented on a television, as described further below, the user can hover or select a moment on the timeline with the remote control associated with the television, or with a remote cursor of the television. When the GUI is implemented on a virtual reality player, as described further below, the user can hover over or select a moment on the timeline with the VR cursor. The additional information can optionally appear above the moment (e.g., for a set period of time, such as for as long as the user hovers over the moment). The additional information can optionally include a name of the person or thing involved in (e.g., that causes) the action or event associated with the moment, a number identifying the person or thing (e.g., the number on the individual's jersey if he or she is on a sport team), and/or a photo of the person or thing involved in the action or event associated with the moment, or a combination of these.

The user can therefore gain information of the moment by first looking at the coded identifier (e.g., color, shape) relative to the key or legend (e.g., displayed on the GUI). To gain additional information, the user can hover over or otherwise select a particular moment, which can provide information such as the name of the person or thing involved in the action or event, as described above. User selection of a particular moment on the video (e.g., by clicking, double-clicking, etc., on the moment) then initiates a playback of the video frames that correspond to the particular action or event.

Accordingly, the user interface advantageously provides the user with substantial information for moments coded onto the video timeline simply by the type of coded identifier displayed on the timeline and via hovering over the moment, both of which do not require the user to interact with the video by advancing the playback of the video to a certain location before obtaining such additional information. As such, the user advantageously browses the coded moments to easily identify the action or event they want to view. This is particularly useful in recorded live events, such as sporting events, where the user may only want to see the scoring events (e.g., goals), and more particularly scoring events by a particular team, in a game without having to watch other events in the game that may not be of interest to the user.

### Creation of Moments

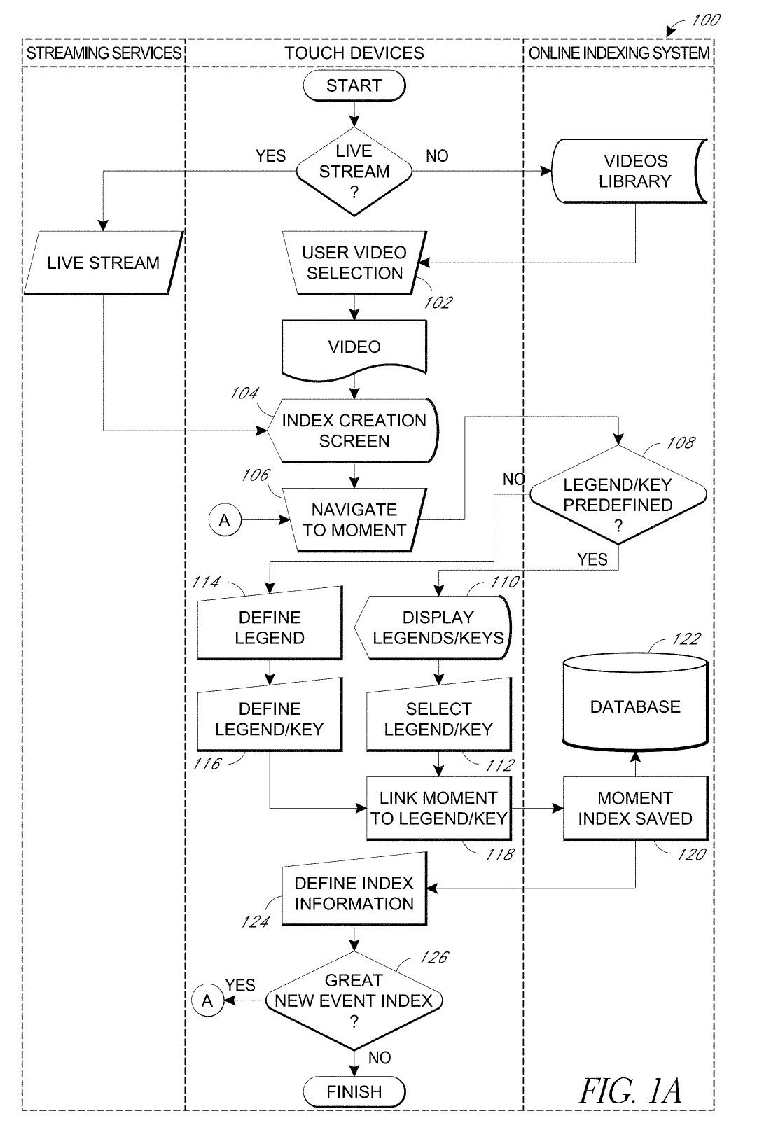

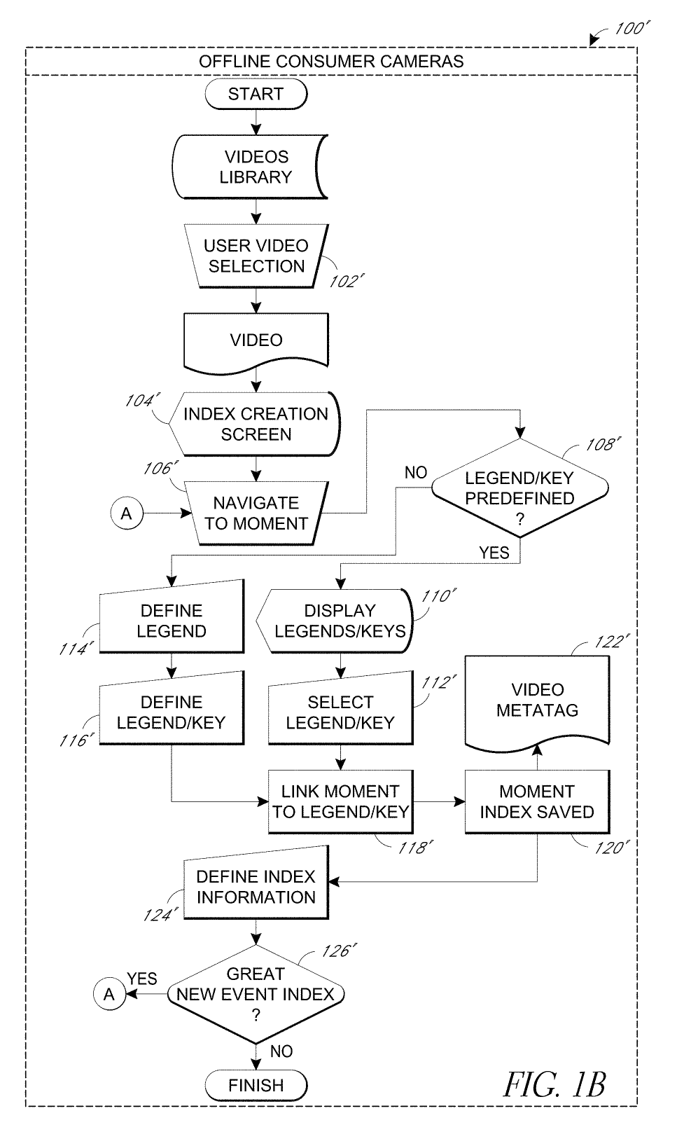

FIG. 1A shows a cross-functional flow chart for a process 100 for implementing the creation of moments on touch devices (e.g., tablet computer, smartphone, laptop with touch screen, etc.) via an interface. Though the process 100 below is described as being implemented via touch devices, one of skill in the art will recognize that the process can be implemented via other devices (e.g., other computer devices).

At the start of the process 100, the user selects 102 the video content. The video content can optionally be a live stream that can optionally originate at a different location and be transmitted to the interface (e.g., wirelessly). Alternatively, the video content can come from a video library. The video library can optionally be stored on the same touch device that has the interface. Alternatively, the video library can be stored in a separate hosted environment that can be accessed (e.g., stored on the cloud and accessed via the internet) by the touch device.

Once the video content has been selected, the user can access 104 an index creation screen (e.g., moment creation screen) on the touch device. For example, the user can launch an app on the touch device that displays the index creation screen. The index creation screen loads in the video content that was selected 102 by the user. The user can then navigate 106 to the moment on the video that they want to index, and access 108 an indexing system (e.g., online indexing system), which can be a database located on a remote server.

The online indexing system can provide the user with one or more legends/keys via the index creation screen that the user can use in indexing the moment on the selected video content. Optionally, the legend is a text associated with the action illustrated by the moment in the video content, and the key is a color associated with the action illustrated by the moment in the video content. Where the user is an authenticated user (e.g., via a login/password entered to access the online indexing system), such as a broadcasting company, a set of predefined legends and keys are displayed 110 to the user and the user can select 112 the desired legends and keys (e.g., via an input box on the index creation screen). For example, one predefined legend can refer to a sporting event (e.g., soccer), where certain keys (e.g., colors) are associated with certain sporting actions (e.g., green for a score, red for a foul, etc.). In another example, one predefined legend can refer to a cooking show or application, where certain keys (e.g., colors) are associated with certain actions of the cooking show or application (e.g., different colors associated with cutting, preparing, frying or serving of food, etc.).

Where the user is not an authenticated user (e.g., the user does not have a specific account with the online indexing system that they have accessed, the user has accessed the online indexing system for free or as a guest user), the online indexing system does not provide the user with predefined legends/keys. Rather the index creation screen can present the user with input boxes via which the user can define 114 the legend and define 116 the legend key. Optionally, the online indexing system can suggest sets of legends via one or more prompts to which the user can respond with a yes or no answer. For example, the online indexing system can prompt the user with a series of questions to determine the nature of the video content (e.g., is the video a travel video?, is the video a sporting event?, is the video a fishing trip?, is the video a wedding?, etc.) to then suggest a legend and legend key for the moment. For example, if the user defines 114 the legend as “travel” via the input box, or if in response to a prompt from the online indexing system the user identifies the video content are relating to “travel”, the online indexing system can provide a set of legends associated with travel, such as “departure”, “at the airport”, “arrival”, “sightseeing”, “return home”, etc. The online indexing system can also provide a set of keys (e.g., set of colors) associated with the set of legends for the type or theme of the video content (e.g., travel) that the user has identified,

Once the legend and legend key have been defined or selected, the selected moment is linked 118 (via the index creation screen) to the legend and legend key that has been defined or selected. The moment index is then saved 120 to a database 122 of the online indexing system (e.g., if the touch device is connected to the online indexing system, such as via the internet). Alternatively, if the touch device is not connected to the internet so that it cannot access the database 122 of the online indexing system, the moment index is saved 120 on a memory of the touch device, and can optionally be later transmitted to the database 122 once the touch device is connected to the internet,

Once the moment index has been saved 120, the user can define 124 index information associated with the moment. That is, the user can input data relevant to the indexed moment, such as optionally providing identifying information of the subject in the moment and relevant data associated with the moment. For example, where the moment relates to a sporting event, such as a soccer match, the index information can include identifying information of the athlete associated with the moment (e.g., a picture of the athlete, the name of the athlete who scored the goal, the jersey number of the athlete, etc.), or can include additional stats associated with the athlete (e.g., number of goals scored in the game, number of goals scored for the season, rank among goal scorers in league, etc.).

Following the user defining 124 index information associated with the selected moment, the user can create 126 a new moment index, which can then allow the system to return to the step where the user navigates 106 to the moment the user wants to select. This process can be repeated multiple times for the user to index multiple moments in the video content via an index creation screen of the touch device, as described above.

FIG. 1B shows a cross-functional flow chart for a process 100′ for implementing the creation of moments on an offline electronic device, such as an offline consumer camera. By offline, it is meant that the electronic device does not communicate with a remote electronic device or server (e.g., does not communicate wirelessly, such as via WiFi, BLUETOOTH®, etc.). Though the process 100′ below is described as being implemented in an offline consumer camera, one of skill in the art will recognize that the process can be implemented via other offline electronic devices (e.g., an offline television). The process 100′ illustrated in FIG. 1B is similar to the process 100 in FIG. 1A, except as noted below. Thus, the reference numerals used to designate the various actions or steps of the process 100′ are identical to those used for identifying corresponding actions or steps of the process 100 in FIG. 1A, except that a “=” has been added to the reference numerals.

In the process 100′, the offline electronic device does not connect to the internet and therefore does not access an online indexing system, like the process 100 in HG. 1A does. In light of this, the video content does not include an external live stream (as in FIG. 1A), and instead the video content that the user can use comes from a video library, which can be accessed via a memory of the offline electronic device, or via an external physical storage (e.g., memory card, memory stick, etc.) that is connected to the offline electronic device. Otherwise, the process 100′ functions in a similar manner as the process 100. Another difference is that the predefined/legend keys are provided to the user via the index creation screen of the electronic device (i.e., without accessing a remote server). Another difference between the process 100′ used for the offline electronic devices (e.g., offline consumer camera) is that the moment index is saved 120′ in a video metatag the 122′ (e.g., mp4 file metadata).

### Graphical User Interface

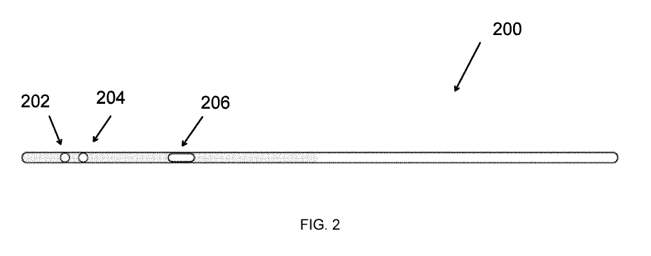

FIG. 2 shows a timeline 200 that can be implemented in the graphical user interface GUI. The timeline 200 can have a plurality of identifiers or markers 202, 204, 206 that identify moments, as discussed above. Though FIG. 2 shows three identifiers 202, 204, 206, one of skill in the art will recognize that the timeline can have fewer or more identifiers. Where several moments are close together, the identifier, such as identifier 206 can have an elongated strip or generally oval shape. The identifiers 202, 204, 206 can optionally have the same shape, such as a circular shape. Other shapes are possible (e.g., square, triangular). The identifiers 202, 204, 206 can optionally have a different color depending on the type of action or event associated with the moment. Though not shown, the GUI can have a legend, optionally near the timeline, to readily identify the type of action or event that is associated with each color for the identifiers. Optionally, once the identifiers are coded to the video, the identifier remains on the timeline that is shown by the GUI.

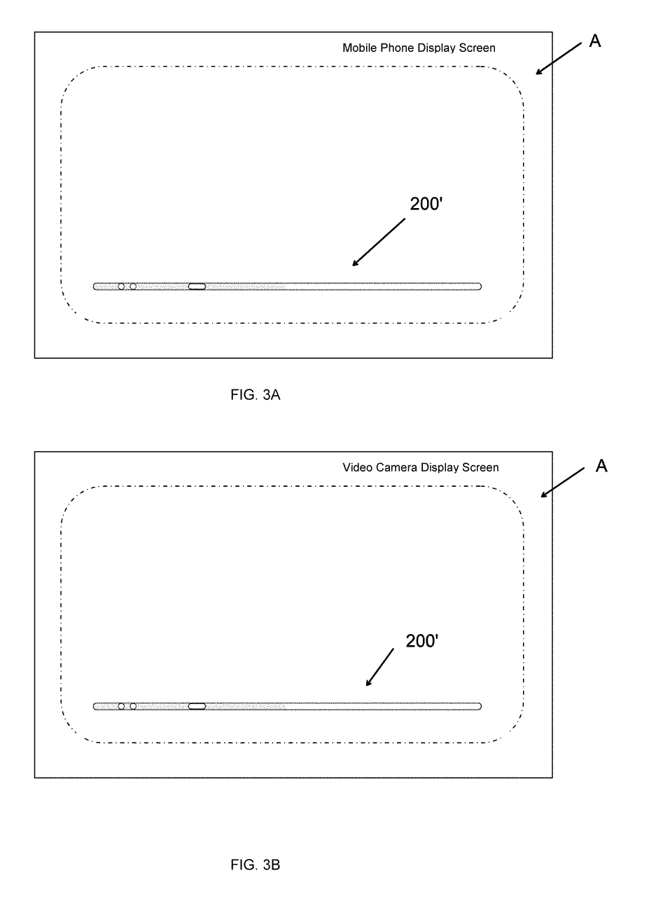

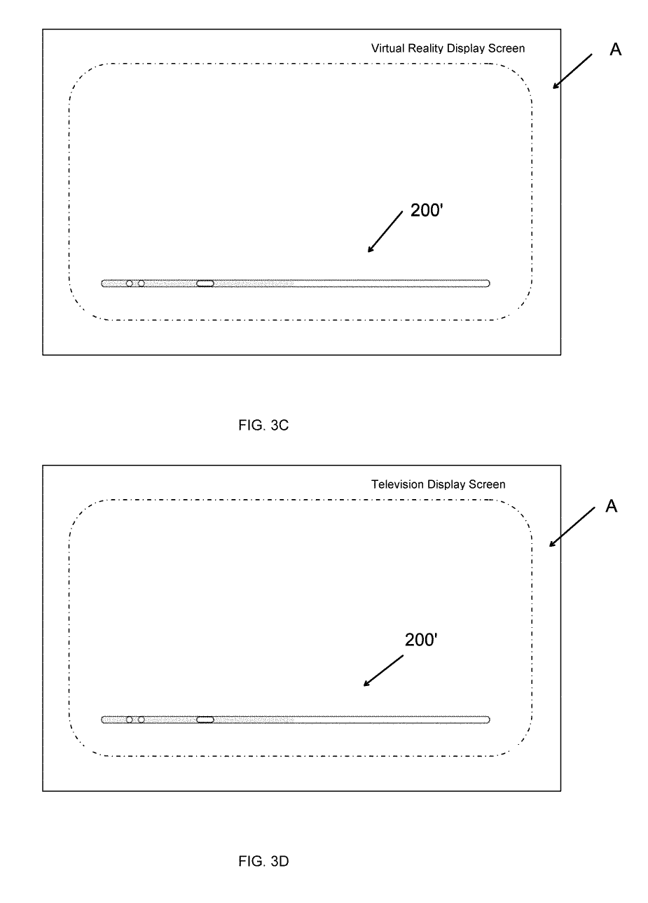

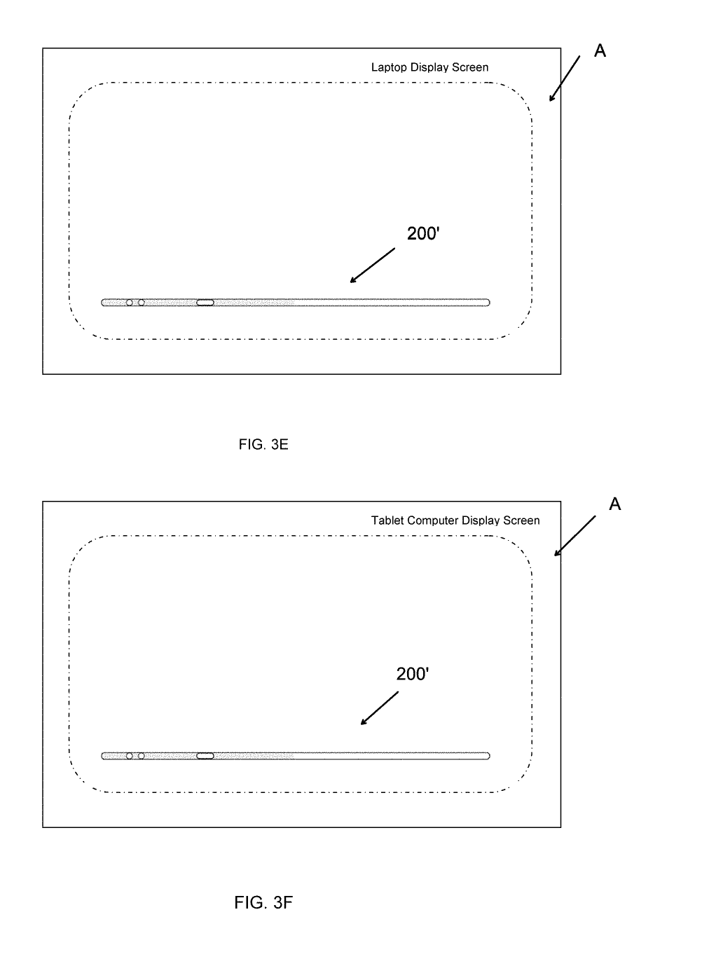

FIGS. 3A-3F show a timeline 200′, similar to the timeline 200 described above, implemented into a graphical user interface on a display screen “A” associated with a variety of electronic devices operable to play video. FIG. 3A shows the timeline 200′ implemented into a video camera display screen, with the rest of the video camera excluded for clarity. FIG. 3B shows the timeline 200′ implemented into a laptop computer display screen, with the rest of the laptop excluded for clarity. FIG. 3C shows the timeline 200′ implemented in a tablet computer display screen, with the rest of the tablet excluded for clarity. FIG. 3D shows the timeline 200 implemented in a mobile phone display screen, with the rest of the mobile phone excluded for clarity. FIG. 3E shows the timeline 200′ implemented in a virtual reality display screen, with the rest of the VR player excluded for clarity. FIG. 3F shows the timeline 200′ implemented in a television screen, with the rest of the television excluded for clarity. One of skill in the art will recognize that the timeline 200′ can be implemented in other electronic devices operable to display a video (e.g., a desktop computer), and that the descriptions above are only examples of devices the graphical user interface can be displayed on.

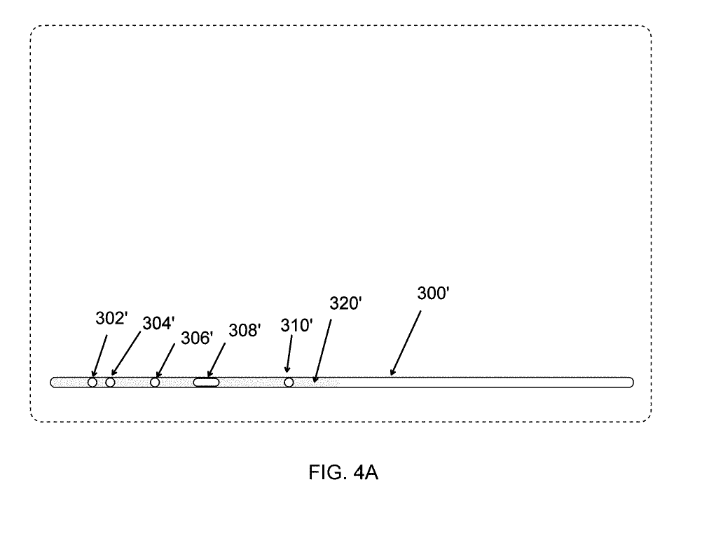

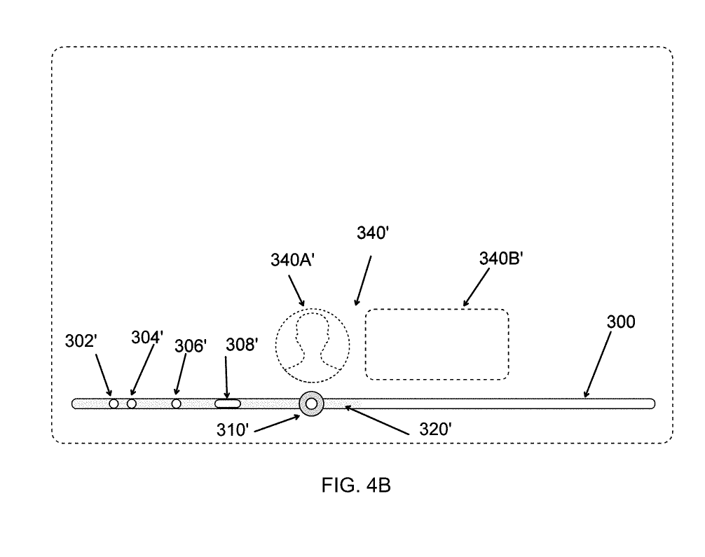

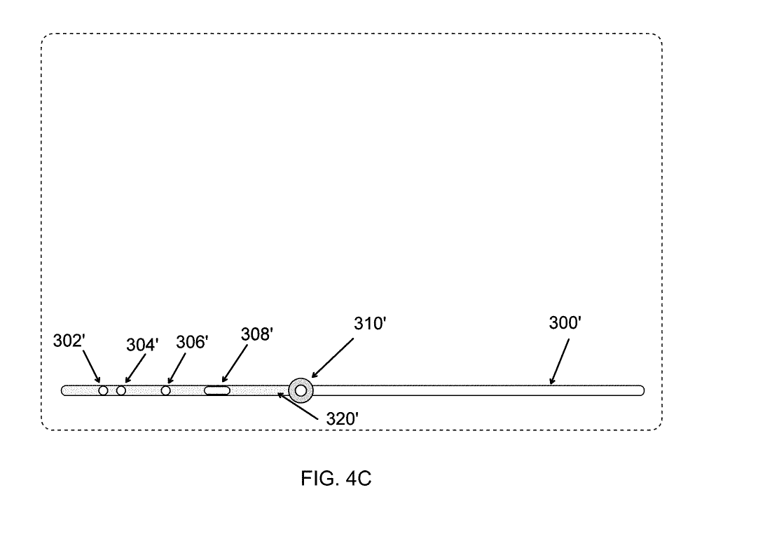

FIGS. 4A-40 show optional representations of a graphical user interface (GUI) that can be applied to the video player interface, such as the electronic devices in FIGS, 3A-3F. FIG. 4A shows a timeline 300′, similar to the timeline 200 in FIG. 2, that includes a plurality of identifiers 302′, 304′, 306′, 308′, 310′. Optionally, the GUI can also include an indication 320′ on the timeline 300′ of where the video is. Optionally, such an indication 320′ can be a darker portion of the timeline. However, the indication 320 can be excluded.

FIG. 4B shows an example of the additional information that can be provided when the user hovers over or selects a particular identifier. When the cursor is operated (by the user) to hover over an identifier, additional information 340′ is provided associated with the moment indexed to that particular identifier 310′. For example, an image 340A′ (e.g., person's face, jersey number, etc.) can appear near the identifier 310′, and can disappear when the user moves away from the identifier 310′. Optionally, a box 340B′ with additional information about the indexed moment associated with the identifier 310′ can also be shown. FIG. 40 shows the GUI once the user has clicked or otherwise selected the identifier 310′, the video skips to the moment associated with the identifier 310′ and initiates playback of the moment associated with the identifier,

As discussed above, the graphical user interface GUI can be implemented into a virtual reality viewer (e.g., in a VR headset). In such an implementation, the user can use the VR cursor to hover over moments to view the additional information associated with said moment. The user can then select the moment with the VR cursor to have the video playback jump to the selected moment.

In another example, the graphical user interface GUI can be implemented into a television display. In such an implementation, the user can use TV's remote control (or alternatively the cursor controlled by the remote control) to hover over moments in the timeline to view the additional information associated with said moment. The user can then select the moment with the television's remote control (e.g., via the cursor controlled by the remote control) to have the video playback jump to the selected moment.

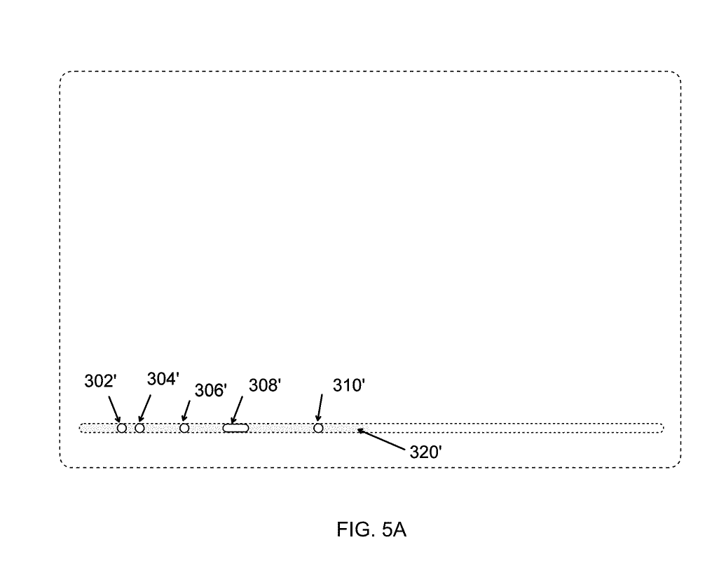

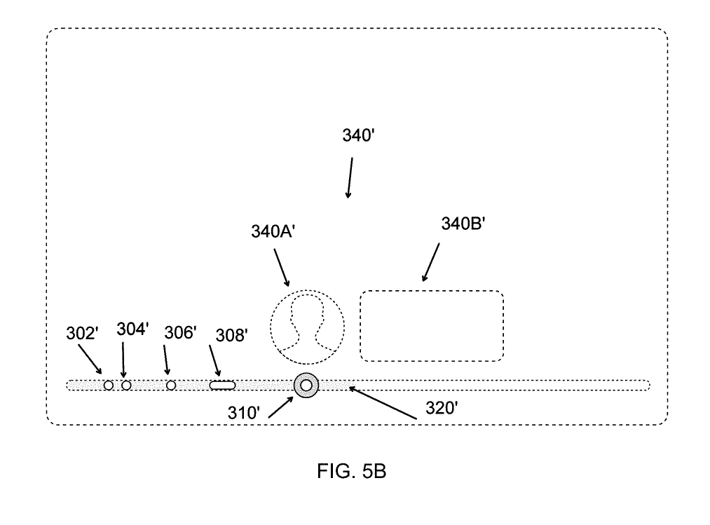

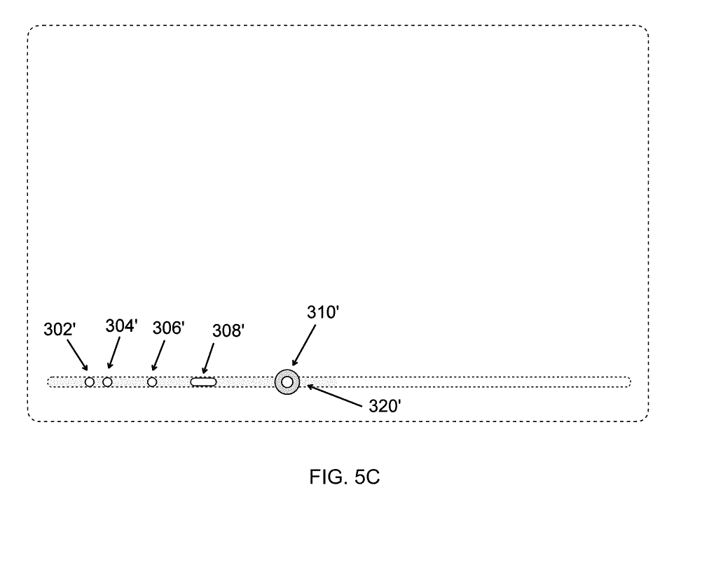

FIGS. 5A-5C show another representation of a graphical user interface (GUI) that can be applied to the video player interface, such as the electronic devices depicted in FIGS. 3A-3F. The GUI illustrated in FIGS. 5A-5C is similar to the GUI shown in FIGS. 4A-4C, except as noted below. Thus, the reference numerals used to designate the various features in the GUI in FIGS. 5A-5C are identical to those used for identifying corresponding features in the GUI in FIGS. 4A-4C.

The GUI in FIGS. 5A-5C differ from the GUI in FIGS. 4A-4C in that the outline of the timeline is excluded. Therefore, as the video plays, the GUI shows the indication 320′ of the location of the video playback, but does not show the outline of the timeline,

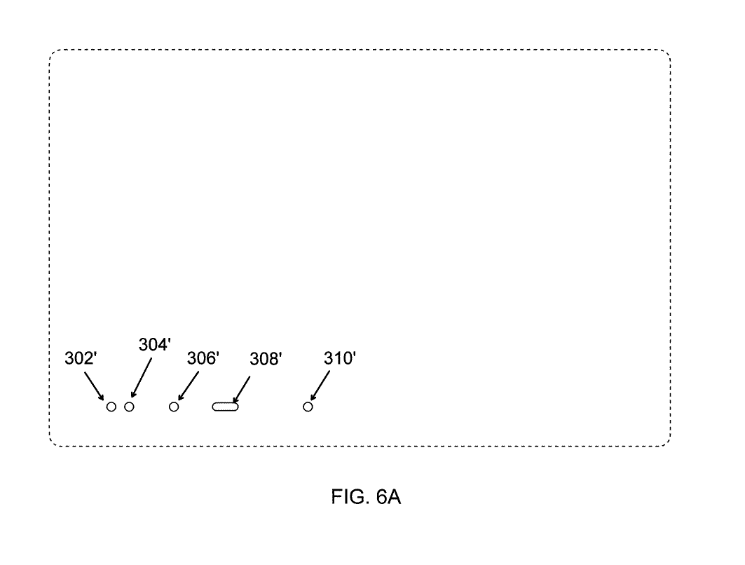

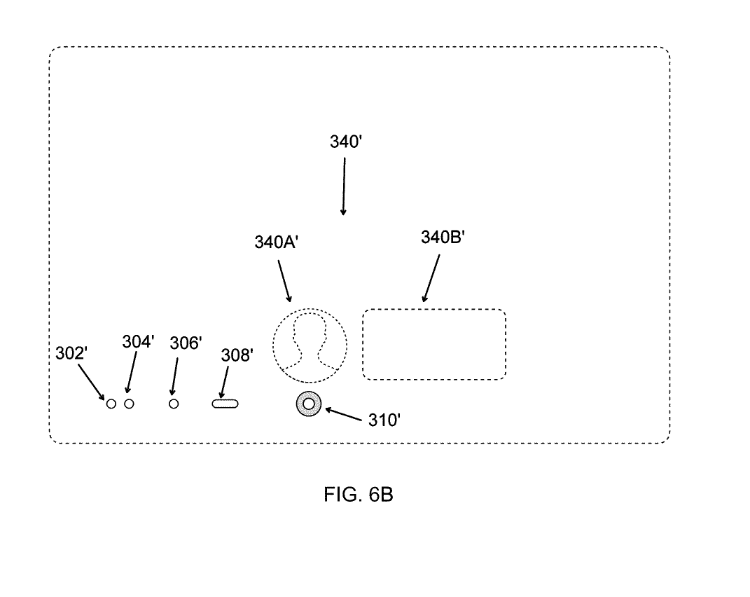

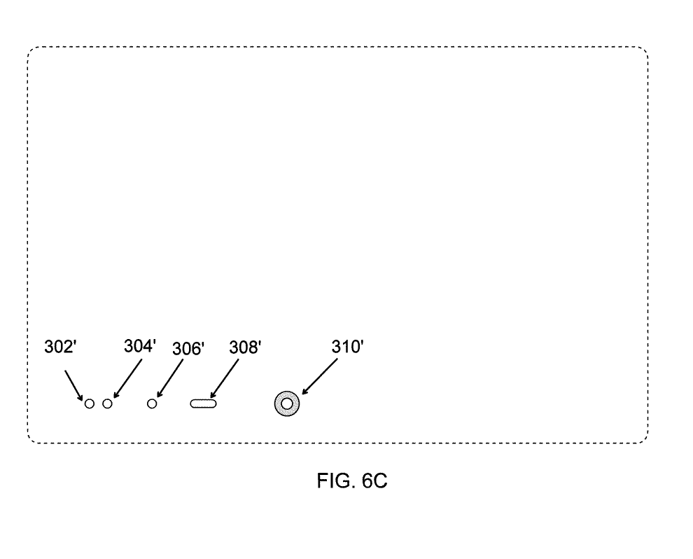

FIGS. 6A-6C show another representation of a graphical user interface (GUI) that can be applied to the video player interface, such as the electronic devices depicted in FIGS. 3A-3F. The GUI illustrated in FIGS. 6A-6C is similar to the GUI shown in FIGS. 4A-4C, except as noted below. Thus, the reference numerals used to designate the various features in the GUI in FIGS. 6A-6C are identical to those used for identifying corresponding features in the GUI in FIGS. 4A-4C.

The GUI in FIGS. 6A-6C differ from the GUI in FIGS. 4A-4C in that the timeline and the indication of the location of the video playback are excluded. Therefore, as the video plays, only the indicators 302′, 304′, 306, 308′ and 310′ show on the screen, and additional information 340′ is shown when the user hovers over a particular moment indicator (e.g., 310′ in FIG. 6B).

### Implementation Mechanism

According to an embodiment, the graphical user interface and other methods and techniques described herein may be implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

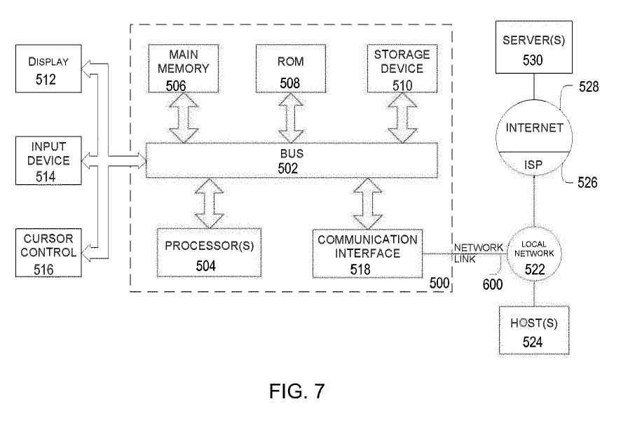

For example, FIG. 7 is a block diagram that illustrates an embodiment of a computer system 500 upon which the various systems and methods discussed herein may be implemented.

Computer system 500 includes a bus 502 or other communication mechanism for communicating information, and a hardware processor, or multiple processors, 504 coupled with bus 502 for processing information. Hardware processor(s) 504 may be, for example, one or more general purpose microprocessors.

Computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

Computer system 500 further may include a read only memory (ROM) 508 or other static storage device coupled to bus 502 for storing static information and instructions for processor 504. A storage device 510, such as a magnetic disk, optical disk, or USB thumb drive (Flash drive), and/or any other suitable data store, is provided and coupled to bus 502 for storing information and instructions, such as video content data, indexing system data, and/or the like.

Computer system 500 may be coupled via bus 502 to a display 512. The display 512 can be one of the displays discussed above (e.g., in a video recorder, mobile phone, tablet computer, laptop computer, television, etc.) for displaying information to a user and/or receiving input from the user. An input device 514, which may include alphanumeric and other keys (e.g., in a remote control), is optionally coupled to bus 502 for communicating information and command selections to processor 504. Another type of user input device is cursor control 516, such as a mouse, a trackball, cursor direction keys, or otherwise a cursor (e.g., a VR cursor, television cursor) for communicating direction information and command selections to processor 504 and for controlling cursor movement on the display 512. This input device typically has at least two degrees of freedom in two axes, a first axis (for example, x) and a second axis (for example, y), that allows the device to specify positions in a plane. In some embodiments, the same direction information and command selections as cursor control may be implemented via receiving touches on a touch screen without a cursor.

Computing system 500 may include a user interface module, and/or various other types of modules to implement one or more graphical user interface, as described above. The modules may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware devices (such as processors and CPUs) may be comprised of connected logic units, such as gates and flip-flops, and/or may be comprised of programmable units, such as programmable gate arrays or processors. Generally, the modules described herein refer to logical modules that may be combined with other modules or divided into sub-modules despite their physical organization or storage. In various embodiments, aspects of the methods and systems described herein may be implemented by one or more hardware devices, for example, as logic circuits. In various embodiments, some aspects of the methods and systems described herein may be implemented as software instructions, while other may be implemented in hardware, in any combination.

As mentioned, computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more modules and/or instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions and/or modules into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

In some embodiments, Computer system 500 may also include a communication interface 518 coupled to bus 502. Communication interface 518 provides a two-way data communication coupling to a network link 600 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN (or WAN component to communicate with a WAN). Wireless links may also be implemented. In any such implementation, communication interface 518 sends and receives electrical, electromagnetic or optical signals that carry digital data streams representing various types of information.

Network link 600 typically provides data communication through one or more networks to other data devices. For example, network link 600 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 600 and through communication interface 518, which carry the digital data to and from computer system 500, are example forms of transmission media.

Computer system 500 can send messages and receive data, including program code, through the network(s), network link 600 and communication interface 518. In the Internet example, a server 530 might transmit a requested code for an application program through Internet 528, ISP 526, local network 522 and communication interface 518. For example, in an embodiment, various aspects of the data analysis system may be implemented on one or more of the servers 530 and may be transmitted to and from the computer system 500. For example, data may be transmitted between computer system 500 and one or more servers 530. In an example, data corresponding to user selection of video content may be transmitted to one or more servers 530, and video content corresponding to such data may then be transmitted back from servers 530. In another example, data corresponding to user selections on an indexing system, and one or more legends/keys corresponding to the user selections on the indexing system can be transmitted back from the servers 530.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the invention need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed embodiments.

1. A computer implemented method for generating and displaying indexed moments on a video player, comprising:
receiving a video content selection;
receiving a selection of one or more moments in the video content;
selecting one or more legends and one or more keys from an indexing system;
linking each of the one or more moments in the video content to one of the one or more legends and to one of the one or more keys to generate one or more indexed moments for the video content;
saving the one or more indexed moments;
receiving and saving identifying information associated with the indexed moment; and
generating in real time a graphical user interface (GUI) that displays a graphical indication of the one or more indexed moments as color-coded indicators, where the GUI temporarily displays the identifying information associated with the indexed moment when a cursor or pointer hovers over the indexed moment.

2. The method of claim 1, wherein the GUI displays the graphical indication of the one or more indexed moments on a video timeline indicative of a time duration of the video.

3. The method of claim 2, wherein the color-coded indicators are displayed as one or more circular markers, each of the circular markers associated with an indexed moment.

4. The method of claim 3, further comprising causing the GUI to display a legend for the color-coded indicators.

5. The method of claim 1, further comprising causing a video content playback to the indexed moment upon receipt of a selection signal for said indexed moment.

6. The method of claim 1, wherein selecting one or more legends and one or more keys from an indexing system comprises accessing an online indexing system.

7. The method of claim 1, wherein selecting video content includes selecting a live stream video content.

8. The method of claim 1, wherein the video player is chosen from a group consisting of a virtual reality player, a mobile phone, a tablet computer, a laptop computer, a desktop computer, a video camera and a television.

9. The method of claim 1, wherein the identifying information includes an image of an individual associated with an action or event of the indexed moment or information associated with said individual.

10. A system for generating indexed moments on a video player, comprising:
one or more computing devices including one or more processors, one or more memory devices;
an application stored in the one or more memory devices and executable by the one or more processors to receive, process, and respond to data requests,
the one or more processors being operable to perform operations comprising:
receiving a video content selection;
receiving a selection of one or more moments in the video content;
selecting one or more legends and one or more keys from an indexing system;
linking each of the one or more moments in the video content to one of the one or more legends and to one of the one or more keys to generate one or more indexed moments for the video content;
saving the one or more indexed moments;
receiving and saving identifying information associated with the indexed moment; and
generating in real time a graphical user interface (GUI) that displays a graphical indication of the one or more indexed moments as color-coded circular markers, where the GUI temporarily displays the identifying information associated with the indexed moment when a cursor or pointer hovers over the indexed moment.

11. The system of claim 10, wherein the video player is chosen from a group consisting of a virtual reality player, a mobile phone, a tablet computer, a laptop computer, a desktop computer, a video camera and a television.

12. The system of claim 10, wherein the application is a web server application that responds to data requests received via one or more network interface devices of the system from an app on a remote electronic device.

13. The system of claim 10, wherein the GUI displays the color-coded circular markers of the one or more indexed moments on a video timeline.

14. The system of claim 10, wherein selecting one or more legends and one or more keys from an indexing system comprises accessing an online indexing system.

15. The system of claim 10, wherein selecting video content includes selecting a live stream video content.

16. A computer program product for generating indexed moments on a video player, the computer program product stored on a computer-readable medium comprising instructions that when executed on a server cause the server to perform operations comprising:
receiving a video content selection;
receiving a selection of one or more moments in the video content;
selecting one or more legends and one or more keys from an indexing system;
linking each of the one or more moments in the video content to one of the one or more legends and to one of the one or more keys to generate one or more indexed moments for the video content;
saving the one or more indexed moments;
receiving and saving identifying information associated with the indexed moment; and
generating in real time a graphical user interface (GUI) that displays a graphical indication of the one or more indexed moments as color-coded indicators, where the GUI temporarily displays the identifying information associated with the indexed moment when a cursor or pointer hovers over the indexed moment.

17. The computer program of claim 16, wherein the color-coded indicators are color-coded circular markers.

18. The computer program of claim 16, wherein the GUI displays the color-coded indicators of the one or more indexed moments on a video timeline.

19. The computer program of claim 16, wherein selecting one or more legends and one or more keys from an indexing system comprises accessing an online indexing system.

20. The computer program of claim 16, wherein the identifying information includes an image of an individual associated with an action or event of the indexed moment or information associated with said individual.
